(19) United States
(12) Patent Application Publication
(10) Pub. No.: US 2008/0151872 A1
(43) Pub. Date: Jun. 26, 2008

(54) VOIP communication system and method

(75) Inventors: Hao Chen, Nanking City (CN); Cheng-Shing Lai, Taipei (TW)

Correspondence Address: BIRCH STEWART KOLASCH & BIRCH, PO BOX 747, FALLS CHURCH, VA, 22040-0747, US

(73) Assignee: Inventec Appliances Corp.

(21) Appl. No.: 11/806,034

(22) Filed: May 29, 2007

(30) Foreign Application Priority Data
Dec. 20, 2006 (TW) 095147810

(51) Int. Cl. H04L 12/66

(52) U.S. Cl. 370/352

(57) ABSTRACT

The invention discloses a VOIP communication system comprising a first VOIP terminal, a user agent, and a second VOIP terminal. The first VOIP terminal is capable of sending a first invite signal complying with a first communication protocol. The user agent is capable of receiving the first invite signal, converting the first invite signal to a second invite signal complying with a second communication protocol, and transmitting the second invite signal. The second VOIP terminal is capable of receiving the second invite signal and sending a second accept signal complying with the second communication protocol to the user agent according to the second invite signal. The user agent converts the second accept signal into a first accept signal complying with the first communication protocol and transmitting the first accept signal to the first VOIP terminal. Thereby, the first VOIP terminal can communicate with the second VOIP terminal.

### BACKGROUND OF THE INVENTION

1. Field of the Invention

The invention relates to a Voice Over Internet Protocol (VOIP) communication system and method and, more particularly to a VOIP communication system and method for establishing communication between different VOIP terminals.

2. Description of the Prior Art

Along with the development of internet technology, the VOIP is getting more popular, and VOIP related technology is also getting more mature. Nowadays. there are many different VOIP protocols such as Session Initiation Protocol (SIP), H.323, Megaco, and the like. Because of the differences of signaling control protocols, voice carriage protocols, and voice encoding formats, VOIP terminals complying with different VOIP protocols can not communicate with each other. Therefore, applications of VOIP will be confined.

Accordingly, the scope of the invention is to provide a VOIP communication system and method to solve the problem mentioned above.

### SUMMARY OF THE INVENTION

A scope of the invention is to provide a VOIP communication system and method for establishing communication between different VOIP terminals.

According to a preferred embodiment of the invention, the VOIP communication system comprises a first VOIP terminal, a user agent, and a second VOIP terminal. The first VOIP terminal is capable of sending a first invite signal complying with a first communication protocol. The user agent is capable of receiving the first invite signal, for converting the first invite signal to a second invite signal complying with a second communication protocol, and for transmitting the second invite signal. The second VOIP terminal is capable of receiving the second invite signal and for sending a second accept signal complying with the second communication protocol to the user agent according to the second invite signal. Afterward, the user agent converts the second accept signal to a first accept signal complying with the first communication protocol and transmits the first accept signal to the first VOIP terminal. Thereby, communication between the first VOIP terminal and the second VOIP terminal will be established.

Accordingly, the VOIP communication system and method according to the invention can establish communication between different VOIP terminals by using the converting function of the use agent.

The advantage and spirit of the invention may be understood by the following recitations together with the appended drawings.

### BRIEF DESCRIPTION OF THE APPENDED DRAWINGS

FIG. 1 is a functional block diagram illustrating VOIP communication system according to a preferred embodiment of the invention;

FIG. 2 illustrates the signal transmission of the VOIP communication system of FIG. 1; and

FIG. 3 is a flow chart of the VOIP communication method according to a preferred embodiment of the invention.

### DETAILED DESCRIPTION OF THE INVENTION

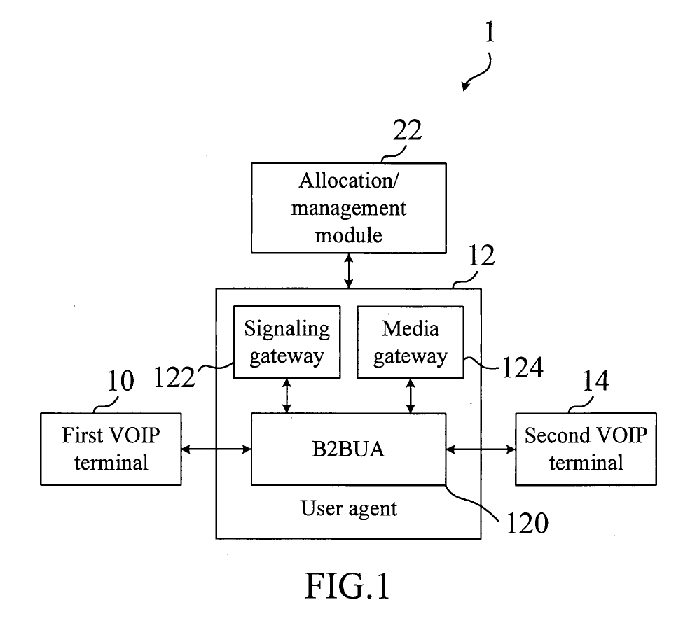

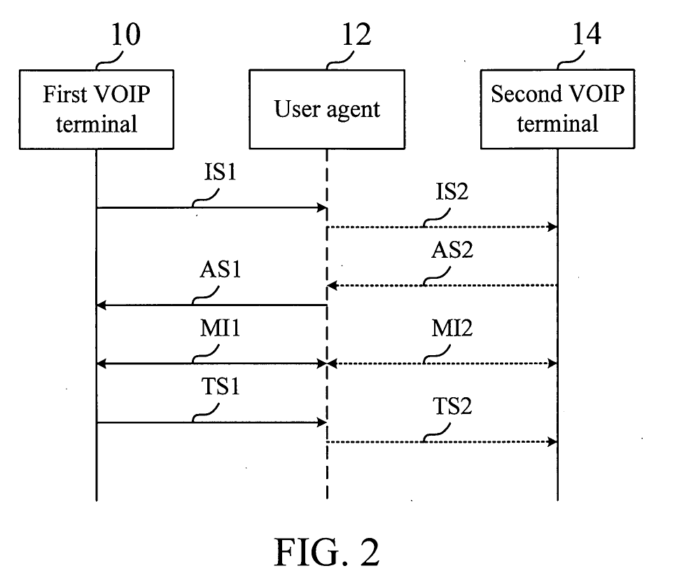

Referring to FIG. 1 and FIG. 2, FIG. 1 is a functional block diagram illustrating VOIP communication system 1 according to a preferred embodiment of the invention. FIG. 2 illustrates the signal transmission of the VOIP communication system 1 of FIG. 1. As shown in FIG. 1, the VOIP communication system 1 comprises a first VOIP terminal 10, a user agent 12, and a second VOIP terminal 14. In practical applications, the first VOIP terminal 10 or the second VOIP terminal 14 can be a SIP terminal, a Skype terminal, an MSN terminal, a Messenger terminal, an AOL messenger terminal, a Yahoo Messenger terminal, or the like. Furthermore, the first VOIP terminal 10 is different from the second terminal 14.

As shown in FIG. 2, when the first VOIP terminal 10 is going to communicate with the second VOIP terminal 14, the first VOIP terminal 10 sends a first invite signal IS1 complying with a first communication protocol to the user agent 12. For example, if the first VOIP terminal 10 is an SIP terminal, the first invite signal IS1 complies with the SIP communication protocol. After receiving the first invite signal IS1, the user agent 12 then converts the first invite signal IS1 to a second invite signal IS2 complying with a second communication protocol and transmits the second invite signal IS2 to the second VOIP terminal 14. For example, if the second VOIP terminal 14 is a Skype terminal, the second invite signal IS2 complies with the Skype communication protocol. After receiving the second invite signal IS2, the second VOIP terminal 14 sends a second accept signal AS2 complying with the second communication protocol to the user agent 12 according to the second invite signal IS2. Then, the user agent 12 converts the second accept signal AS2 to a first accept signal AS1 complying with the first communication protocol and transmits the first accept signal AS1 to the first VOIP terminal 10. Thereby, the first VOIP terminal 10 can communicate with the second VOIP terminal 14 according to the first accept signal AS1.

In practical applications, the user agent 12 can include a back to back user agent (B2BUA) 120 and a signaling gateway 122. The B2BUA 120 is capable of receiving the first invite signal IS1, the second invite signal IS2, the first accept signal AS1, and the second accept signal AS2. The signaling gateway 122 is capable of converting the first invite signal IS1 to the second invite signal IS2 and for converting the second accept signal AS2 to the first accept signal AS1.

In this embodiment, when the first VOIP terminal 10 is communicating with the second VOIP terminal 14, the first VOIP terminal 10 can send a first media information MI1 complying with a first encoding format to the user agent 12. Afterward, the user agent 12 converts the first media information MI1 to a second media information MI2 complying with a second encoding format and transmits the second media information MI2 to the second VOIP terminal 14. The first media information MI1 or the second media information MI2 can include a text, a picture, a video, an audio, an animation, or the like. For example, a user A (not shown) and a user B (not shown) can send audio signals to each other via the VOIP communication system 1 and thereby talk to each other. The user A and the user B can also send video/picture files to each other via the VOIP communication system 1 and thereby share information with each other.

In practical applications, the B2BUA 120 can receive and transmit the first media information MI1 and the second media information MI2. The user agent 12 can further include a media gateway 124 for converting the first media information MI1 to the second media information M12.

In this embodiment, when the first VOIP terminal 10 is going to terminate the communication with the second VOIP terminal 14, the first VOIP terminal 10 sends a first terminate signal TS1 complying with the first communication protocol to the user agent 12. Thereafter, the user agent 12 converts the first terminate signal TS1 to a second terminate signal TS2 complying with the second communication protocol and transmits the second terminate signal TS2 to the second VOIP terminal 14. After receiving the second terminate signal TS2, the second VOIP terminal 14 terminates the communication with the first VOIP terminal 10 according to the second terminate signal TS2.

In this embodiment, the VOIP communication system 1 can further include an allocation/management module 22 for defining a relationship between the first VOIP terminal 10 and the second VOIP terminal 14.

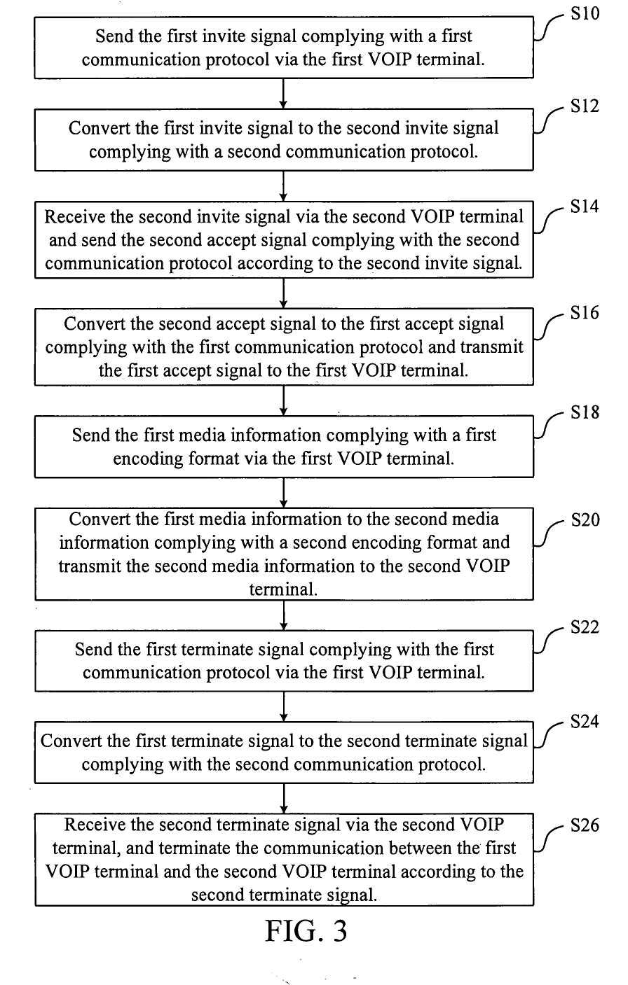

Referring to FIG. 2 and FIG. 3, FIG. 3 is a flow chart of the VOIP communication method according to a preferred embodiment of the invention. As shown in FIG. 3, the VOIP communication method comprises the following steps. First, the method performs step S10 to send the first invite signal IS1 complying with a first communication protocol via the first VOIP terminal 10. Then, the method performs step S12 to convert the first terminate signal IS1 to the second terminate signal IS2 complying with the second communication protocol. After that, the method performs step S14 to receive the second invite signal IS2 via the second VOIP terminal 14 and send the second accept signal AS2 complying with the second communication protocol according to the second invite signal IS2. Thereafter, the method performs step S16 to convert the second accept signal AS2 to the first accept signal AS1 complying with the first communication protocol and transmit the first accept signal AS1 to the first VOIP terminal 10. Thereby, the communication between the first VOIP terminal 10 and the second VOIP terminal 14 is established.

In this embodiment, when the first VOIP terminal 10 is communicating with the second VOIP terminal 14, the VOIP communication method further comprises the following steps. The method performs step S18 to send the first media information MI1 complying with a first encoding format via the first VOIP terminal 10. Then, the method performs step S20 to convert the first media information MI1 to the second media information MI2 complying with a second encoding format and transmit the second media information MI2 to the second VOIP terminal 14.

In this embodiment, when the communication between the first VOIP terminal 10 and the second VOIP terminal 14 is going to be terminated, the VOIP communication method further comprises the following steps. The method performs step S22 to send the first terminate signal TS1 complying with the first communication protocol via the first VOIP terminal 10. Then, the method performs step S24 to convert the first terminate signal TS1 to the second terminate signal TS2 complying with the second communication protocol. After that, the method performs step S26 to receive the second terminate signal TS2 via the second VOIP terminal 14 and to terminate communication between the first VOIP terminal 10 and the second VOIP terminal 14 according to the second terminate signal TS2.

Comparing with prior arts, the VOIP communication system and method according to the invention can establish communication between different VOIP terminals by using the converting function of the use agent. Furthermore, the VOIP communication system and method according to the invention can receive and transmit media information during the communication.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A voice over internet protocol (VOIP) communication system, comprising:
a first VOIP terminal for sending a first invite signal complying with a first communication protocol;
a user agent for receiving the first invite signal, converting the first invite signal to a second invite signal complying with a second communication protocol, and transmitting the second invite signal; and
a second VOIP terminal for receiving the second invite signal and sending a second accept signal complying with the second communication protocol to the user agent according to the second invite signal, the user agent converting the second accept signal to a first accept signal complying with the first communication protocol and transmitting the first accept signal to the first VOIP terminal;
thereby, the communication between the first VOIP terminal and the second VOIP terminal is established.

2. The VOIP communication system of claim 1, wherein the user agent comprises:
a back to back user agent (B2BUA) for receiving and transmitting the first invite signal, the second invite signal, the first accept signal, and the second accept signal; and
a signaling gateway for converting the first invite signal to the second invite signal and converting the second accept signal to the first accept signal.

3. The VOIP communication system of claim 1, wherein when the first VOIP terminal is communicating with the second VOIP terminal, the first VOIP terminal further sends a first media information complying with a first encoding format to the user agent, the user agent converts the first media information to a second media information complying with a second encoding format and transmits the second media information to the second VOIP terminal.

4. The VOIP communication system of claim 3, wherein the user agent comprises:
a back to back user agent (B2BUA) for receiving and transmitting the first media information and the second media information; and
a media gateway for converting the first media information to the second media information.

5. The VOIP communication system of claim 3, wherein the first media information or the second media information comprises a text, a picture, a video, an audio, or an animation.

6. The VOIP communication system of claim 1, wherein when the first VOIP terminal is going to terminate the communication with the second VOIP terminal, the first VOIP terminal sends a first terminate signal complying with the first communication protocol to the user agent, the user agent converts the first terminate signal to a second terminate signal complying with the second communication protocol and transmits the second terminate signal to the second VOIP terminal, the second VOIP terminal receives the second terminate signal and terminates the communication with the first VOIP terminal according to the second terminate signal.

7. The VOIP communication system of claim 1, wherein the first VOIP terminal comprises a session initiation protocol (SIP) terminal, a Skype terminal, an MSN Messenger terminal, an AOL Messenger terminal, or a Yahoo Messenger terminal.

8. The VOIP communication system of claim 1, wherein the second VOIP terminal comprises a session initiation protocol (SIP) terminal, a Skype terminal, an MSN Messenger terminal, an AOL Messenger terminal, or a Yahoo Messenger terminal.

9. The VOIP communication system of claim 1, further comprising an allocation/management module for defining a relationship between the first VOIP terminal and the second VOIP terminal.

10. A voice over internet protocol (VOIP) communication method, comprising the steps of:
(a) sending a first invite signal complying with a first communication protocol via a first VOIP terminal;
(b) converting the first invite signal to a second invite signal complying with a second communication protocol;
(c) receiving the second invite signal via a second VOIP terminal and sending a second accept signal complying with the second communication protocol according to the second invite signal; and
(d) converting the second accept signal to a first accept signal complying with the first communication protocol and transmitting the first accept signal to the first VOIP terminal;
thereby, the communication between the first VOIP terminal and the second VOIP terminal is established.

11. The VOIP communication method of claim 10, when the first VOIP terminal is communicating with the second VOIP terminal, the method further comprising the steps of:
(e) sending a first media information complying with a first encoding format via the first VOIP terminal; and
(f) converting the first media information to a second media information complying with a second encoding format and transmitting the second media information to the second VOIP terminal.

12. The VOIP communication method of claim 11, wherein the first media information or the second media information comprises a text, a picture, a video, an audio, or an animation.

13. The VOIP communication method of claim 10, when the communication between the first VOIP terminal and the second VOIP terminal is going to be terminated, the method further comprising the steps of:
(g) sending a first terminate signal complying with the first communication protocol via the first VOIP terminal;
(h) converting the first terminate signal to a second terminate signal complying with the second communication protocol; and
(i) receiving the second terminate signal via the second VOIP terminal, and terminating the communication between the first VOIP terminal and the second VOIP terminal according to the second terminate signal.

14. The VOIP communication method of claim 10, wherein the first VOIP terminal comprises a session initiation protocol (SIP) terminal, a Skype terminal, an MSN Messenger terminal, an AOL Messenger terminal, or a Yahoo Messenger terminal.

15. The VOIP communication method of claim 10, wherein the second VOIP terminal comprises a session initiation protocol (SIP) terminal, a Skype terminal, an MSN Messenger terminal, an AOL Messenger terminal, or a Yahoo Messenger terminal.

16. The VOIP communication method of claim 10, further comprising the step of:
defining a relationship between the first VOIP terminal and the second VOIP terminal.
